(19) United States
(12) Patent Application Publication
(10) Pub. No.: US 2026/0301746 A1
(43) Pub. Date: Oct. 1, 2026

(54) REAL-TIME STOPPING DECISIONS FOR VOICE AUTHENTICATION

(71) Applicant: MICROSOFT TECHNOLOGY LICENSING, LLC., REDMOND, WA (US)

(72) Inventor: HAYDAR TALIB, MONTREAL (CA)

(21) Appl. No.: 19/090,256

(22) Filed: Mar. 25, 2025

(51) Int. Cl. G10L 17/04; G06F 21/32

(52) U.S. Cl. CPC G10L 17/04; G06F 21/32

(57) ABSTRACT

The decision thresholds for a speaker recognition system are pre-computed based on scores from trials consisting of imposter voice samples and authentic voice samples and are used in real-time for the system to make a decision to accept or reject a voice input at an earlier checkpoint with minimal accuracy loss. The speaker recognition system is represented as a Markov Decision Process (MDP) using scores from the trials generated at multiple checkpoints. A reinforcement learning solution is then used to determine the optimal policy for the MDP. The optimal policy is applied to the scores from the trials to extrapolate the decision thresholds for each checkpoint.

### BACKGROUND

Speaker recognition systems based on voice biometrics are often used to perform remote authentication over the telephone. Various applications use these systems for entry control to restricted premises, access to privileged information, funds transfer, credit card authorization, voice banking, and others.

A speaker recognition system works by analyzing unique characteristics of a person's voice, extracting features from a spoken audio sample, and comparing them to a pre-recorded voice print, to generate a similarity score. The similarity score is compared against a predefined decision threshold to determine whether the similarity score is high enough to accept the speaker as authentic. If the similarity score exceeds the decision threshold, the system accepts the speaker; otherwise, it rejects the speaker.

Resource consumption of a speaker recognition system is a key factor for the real-time performance of the system in devices where power consumption and processing speed are limited such as in mobile devices. The system consumes fewer computing resources when the system is able to make a decision quickly which may not always result in an accurate decision. Hence, there is a need to balance the timeliness of a decision against a higher accuracy of the decision.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A speaker recognition system pre-computes the decision thresholds from modeling the system as a Markov Decision Process (MDP) and using reinforcement learning to generate an optimal policy that achieves a maximum cumulative reward over time. The modeling of the speaker recognition system as a MDP allows for the decision thresholds to be generated balancing the tradeoff of early decisions with minimal accuracy loss against waiting to make a decision with the expectation that more information will achieve higher accuracy.

The speaker recognition system is modeled as an MDP consisting of states, actions, transition probabilities, rewards, and a discount factor. The data used to model the speaker recognition system comes from scores generated from trials of the speaker recognition system on imposter and authentic data. A state represents a score at one checkpoint from the trials and the actions are operations that transition one state to another state until a terminal state is reached. The rewards and discount factor are set to discourage waiting and to promote early decisions with minimal accuracy loss that is achieved by defining the transition probabilities based on a particular false acceptance rate (FAR) and false rejection rate (FRR). Reinforcement learning is used to generate the solution to the MDP which is an optimal policy. The optimal policy represents the best action to take in a particular state that maximizes the cumulative reward over time. The optimal policy is then used to determine the decision thresholds.

The decision thresholds are then used by the speaker recognition system in real-time to determine whether the system may make a decision at an earlier checkpoint with minimal accuracy loss over waiting with the expectation that a future checkpoint with more information would be more accurate. As such, the real-time performance of the speaker recognition system is improved since the resource usage and power consumption of the device is reduced in addition to the operational costs realized by the enterprise customers using the speaker recognition system.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF DRAWINGS

FIG. 1 is a graph depicting speaker recognition scores over time at several checkpoints with corresponding accept and reject thresholds.

FIG. 2 is an illustration of the speaker recognition system designed as a Markov Design Process.

FIG. 3A is a schematic diagram that illustrates components of a speaker recognition system that generate the decision thresholds. FIG. 3B is a schematic diagram that illustrates components of the real-time speaker recognition system for voice authentication.

FIG. 4 is a flow chart of an example of a method for determining the optimal decision thresholds.

FIG. 5 is a flow chart of an example of a method for authenticating a voice input in real time.

FIG. 6 is a block diagram illustrating an example of an operating environment.

FIG. 7 is a schematic diagram illustrating a method for generating accept/reject decision thresholds from scores generated from trials.

### DETAILED DESCRIPTION

### Overview

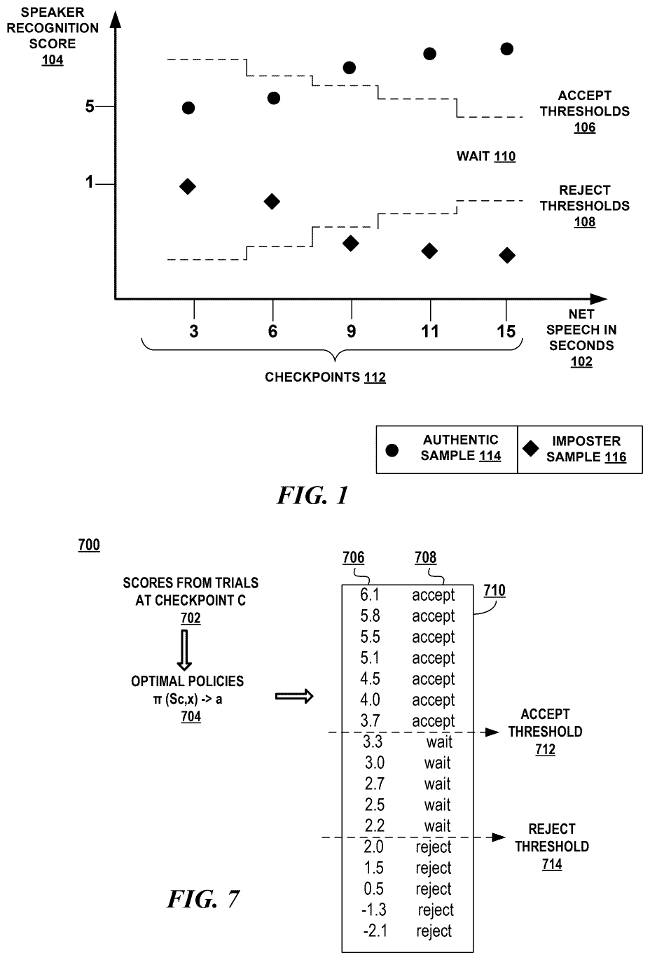

FIG. 1 is an illustration of how scores from a speaker recognition system change over time as more speaker audio is processed. The graph 100 shown in FIG. 1 illustrates the speaker recognition scores 104, on the y-axis, plotted against a set of checkpoints 112, on the x-axis 102, ranging from 3 seconds to 15 seconds (i.e., net speech in seconds), with accept thresholds 106 and reject thresholds 108 at each checkpoint. A checkpoint 112 is a point in time when a decision may be made. The circle-shaped points 114 illustrate a sequence of scores that lead to an acceptance of a voice input as authentic and the diamond-shaped points 116 illustrate a sequence of scores that lead to a rejection of the voice input. Once a score passes a threshold, a decision can be made and the speaker recognition system stops processing the voice input.

The circle-shaped points representing the scores of an authentic sample 114 that cross over the accept threshold at the 9 second checkpoint, allow the speaker recognition system to accept the voice input as authentic and to stop processing the voice input. The diamond-shaped points represent an imposter sample 116 and cross over the reject threshold at the 9 second checkpoint thereby allowing the speaker recognition system to reject the voice input. The region between the accept thresholds 106 and the reject thresholds is where the speaker recognition system waits 110 for the next checkpoint to make a decision.

The score distribution at each checkpoint and how the scores change over time are used to model the speaker recognition system as an MDP. Trials consisting of authentic and imposter voice samples are used by the speaker recognition system to generate scores at each checkpoint. The MDP is represented as a 5-tuple (S, A, T, R, Y), where S is a set of states and a state s is a speaker recognition score b at checkpoint c or a terminal state. A terminal state represents an outcome that terminates the processing of the speaker recognition system and includes correct acceptance (CA), false acceptance (FA), correct rejection (CR), or false rejection (FR). “A” is a set of actions available in a state and consists of accept, reject and wait.

“T” is a transition model that specifies a conditional probability of transitioning to a next state s′ when taking the action, a at a current state s. The conditional probabilities of the transition model are exclusively based on the FAR and FRR values of each state from the scores produced from the trials. In an aspect, a very low FAR, in the range of 0.1% to 0.5%, is preferred although the target FAR/FRR values are set according to a desired security level for a given application. The conditional probabilities of the transition model are described in more detail below.

“R” is a reward function, R (s, a), that specifies an immediate reward for taking action a when in state s. The reward indicates which state-action pairs are good and which are bad and the system uses this information to maximize the total cumulative reward over time. The discount factor γ typically ranges from 0 to 1 where a higher value places more emphasis on future rewards, while a lower value prioritizes immediate rewards. The rewards and the discount factor are configured to achieve a particular objective, such as without limitation, earlier decisions with minimal accuracy loss. The rewards are discussed in more detail below.

The MDP represents a decision-making process in situations where the outcome is unpredictable and the task exhibits a Markov property. A Markov property is where the probability of the next state is based on the current state and not on the previous states. Once the speaker recognition system is modeled as an MDP, a reinforcement learning technique is used to find the optimal policy that specifies the best action to take when in a particular state.

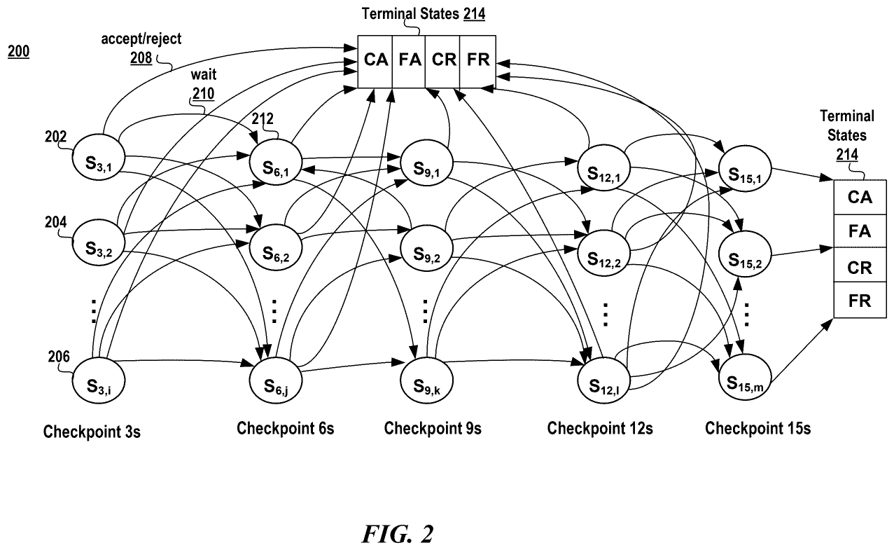

FIG. 2 depicts an illustration of a speaker recognition system as an MDP. The MDP 200 consists of a set of states where each state represents a score at a particular checkpoint or a terminal state 214. For example, state 202 represents a score S_{3,1} output from a scoring component at checkpoint 3 seconds (3 s) where the score is listed in position 1 of a score list, state 204 represents a score S_{3,2} output from the scoring component at checkpoint 3 s where the score is listed in position 2 of the score list, and state 206 represents a score S_{3,i} output from the scoring component at checkpoint 3 s where the score is listed in position i of the score list.

Each state at checkpoints 3 s, 6 seconds (6 s), 9 seconds (9 s), and 12 seconds (12 s) links to a next state based on an action taken in the current state. For example, state 202 transitions to state 212 when a wait action 210 is applied in state 202. State 202 transitions to the terminal state of correct acceptance or false acceptance when an accept action 208 is applied to state 202. State 202 transitions to the terminal state of correct rejection or false rejection 214 when a reject action 208 is applied to state 202.

An action includes wait, accept or reject. The accept and reject actions result in a terminal state 214. An accept action results in the terminal state of correct acceptance CA or false acceptance FA and the reject action results in the terminal state of either correct rejection CR or false rejection FR. The only actions available at checkpoint 15 s are accept and reject resulting in the terminal states 214 of CA, FA, CR or FR. The wait action delays a decision to the next checkpoint.

Reinforcement learning is a machine learning technique where an agent interacts with an environment to determine the ideal behavior in a specific context in order maximize a reward. The agent learns to take an action given the state of the environment and a reward that it aims to maximize over time. The environment provides a reward and the agent, as a learning system, takes actions within an environment to maximize the reward. The reward indicates how well the agent is performing at each step.

Modeling the speaker recognition system as a MDP allows the speaker recognition system to consider other objectives for generating the decision thresholds than high accuracy. Decision-making processes are about making tradeoffs to achieve a particular objective. In the present case, the MDP allows the speaker recognition system to consider early decisions through the configuration of the rewards and the discount factor and to do so with minimal accuracy loss using the transition probabilities based on achieving a particular FAR/FRR. Reinforcement learning provides the MDP with a solution to achieve this objective by determining the optimal policy that solves the MDP.

In reinforcement learning, an optimal policy is one that maximizes the cumulative reward compared to all other possible policies, ensuring the agent makes the best decisions to achieve its goals. A policy is a mapping of state s to action a. An optimal policy indicates the best action a to be taken while in state s that achieves the maximum cumulative reward over time. The maximum cumulative reward is the highest possible total reward an agent can achieve over a sequence of actions. Reinforcement learning aims to learn policies that maximize this cumulative reward.

In an aspect, the policy iteration technique is used to determine the optimal policy for the speaker recognition system represented as an MDP. The optimal policy is applied to the scores from the trials. The distribution of the scores from the trials, the rewards for the different state-action pairs, and the discount factor are used to determine the best value that represents the accept threshold and the best value that represents the reject threshold at a checkpoint.

The technique disclosed herein is advantageous over alternative solutions that make the decision to accept or reject the speaker at a single pre-determined point in time or by defining a sequence of specific decision points over a fixed duration. The alternative solutions rely on decision thresholds that achieved high accuracy without any consideration of balancing the timeliness of a decision against the higher accuracy in an optimal way.

Accordingly, aspects of the subject matter disclosed herein pertain to the technical problem of determining the optimal accept and reject decision thresholds for each checkpoint of a real-time speaker recognition system. The technical features associated with addressing this problem includes formulating the speaker recognition system as a Markov Decision Process using prior information on score distributions over time and how they change over time with parameters (e.g., rewards, discount factor, transition probabilities) set towards early decisions with minimal accuracy loss. The technical feature of reinforcement learning is then applied to the MDP to determine the optimal policy for each state that generates the optimal action that produces the maximum cumulative reward. The technical effect is the determination of the optimal decision thresholds that enable a decision to be made earlier thereby reducing computational resources and operating costs of the speaker recognition system.

Attention now turns to a more detailed description of the components, methods, processes, and system for automating the generation of an enhanced email text message.

### System

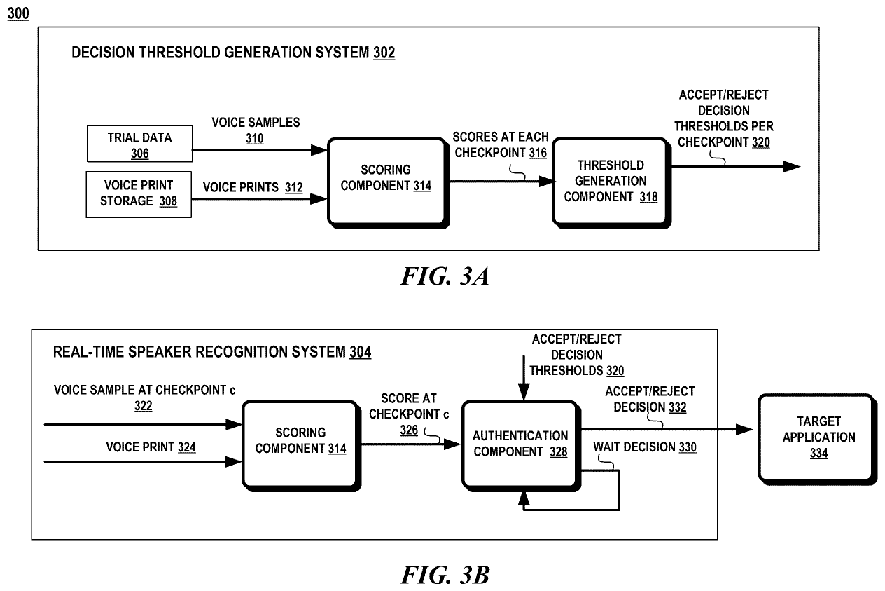

FIGS. 3A-3B illustrate an example of a system 300 in which various aspects of the invention may be practiced. FIG. 3A illustrates an example of a decision threshold generation system 302 and FIG. 3B illustrates an example of a real-time speaker recognition system 304. The decision threshold generation system 302 determines the decision thresholds prior to the real-time authentication of a speaker's voice, and the real-time speaker recognition system 304 uses the pre-configured decision thresholds to authenticate a speaker's voice.

The decision threshold generation system 302 uses trials 306 composed of authentic and imposter voice samples 310, scoring them against a previously-created voice print of a speaker 312 stored in a voice print storage 308. A score is generated by a scoring component 314 at each checkpoint which is a numerical value that indicates the likelihood of a voice sample matching the speaker, essentially representing the degree of similarity between the voice sample and the voice print of the speaker. A higher score usually means a greater probability of a match.

The scoring component 314 receives a voice sample as an audio signal using any suitable technique. In an aspect, the scoring component 314 extracts features from the audio signal and compares the extracted features with a previously-created voice print of the speaker. The extracted features may include spectral features (e.g., Mel-Frequency Cepstral Coefficients, spectral centroid, spectral flux, spectral bandwidth), temporal features (e.g., zero-crossing rate, root mean square energy), and other features (e.g., pitch, tone, speech patterns) that represent the essential qualities of sound. The extracted features form a speaker profile which is a unique voice signature created from analyzing the extracted features. The speaker profile is generated using techniques, such as, deep neural network (DNN) based speaker embeddings, that capture the speaker's unique voice features and acts as a voice print for speaker recognition purposes.

The threshold decision component 318 analyzes the scores from each checkpoint 316 and generates an accept and reject threshold for each checkpoint 320. The threshold decision component 318 is described in more detail below.

The real-time speaker recognition system 304 then uses the decision thresholds to authenticate or reject a speaker's voice input. At each checkpoint or decision time step, a voice input of a speaker 322 and the speaker's pre-existing voice print 324 are scored by the scoring component 314 until the system makes a decision. An authentication component 328 compares the score at the checkpoint 326 against the decision thresholds to decide whether to accept or reject the speaker's voice input at that checkpoint 332 or to wait for the next checkpoint 330. Once a decision is made by the authentication component 328, either at the last checkpoint or at an earlier checkpoint, the decision 332 is output to a target application 334.

In an aspect, the real-time speaker recognition system 304 operates in a background process of a target application 334, which uses the system 304 to authenticate a person's identity through their voice. Examples of a target application 334 include without limitation, call centers that identify callers to provide a personalized service without requiring passwords, voice-activated assistants that provide responses on a smart device based on a user's voice, mobile applications that verify a user's voice, banking and financial services that authenticate a user for secure transactions, deepfake speech detection, health care application services that verify a patient during telemedical consultations, conference call services that identify speakers during a conference, and the like.

It should be noted that the technique described herein is not limited to voice recognition and can be applied to any type of time-dependent processing (e.g., streaming processing). Examples include without limitation conversation print technology where the textual component of speech, provided via automatic speech recognition, is analyzed to confirm a speaker's unique language patterns or patterns representing a fraudulent behavior.

Other biometrics that can benefit from the disclosed technique include time-varying signals that include gesture-based biometrics, such as a how a user interacts with their device through a touchscreen, keystrokes, mouse movements, and the like. Other examples include face recognition and deepfake detection in video, where an image changes over time.

### Methods

Attention now turns to description of various examples of methods that utilize the system and device disclosed herein. Operations for the aspects may be further described with reference to various methods. It may be appreciated that the representative methods do not necessarily have to be executed in the order presented, or in any particular order, unless otherwise indicated. Moreover, various activities described with respect to the methods can be executed in serial or parallel fashion, or any combination of serial and parallel operations. In one or more aspects, the method illustrates operations for the systems and devices disclosed herein.

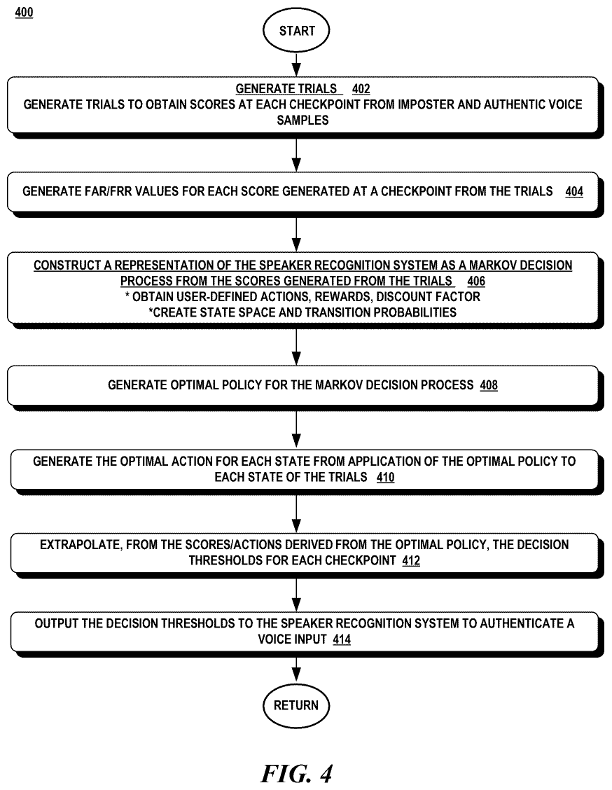

Turning to FIG. 4, there is shown a method 400 for generating the optimal decision thresholds. Initially, scores are generated by the scoring component 314 from trials consisting of authentic voice samples and imposter voice samples (block 402). An authentic voice sample consists of a voice biometric from a user having a speaker profile on the system. The imposter voice sample consists of a voice biometric from a user not having a genuine speaker profile with the system. The authentic voice samples and the imposter voice samples are input into the scoring component 314 which outputs a respective score. The score represents a similarity of the voice sample to the speaker profile of the speaker in the system.

The scores from the trials are then used by the scoring component 314 to compute the FRR/FAR values for each state (block 404). The FAR measures the proportion of imposter speakers who are inaccurately matched to a speaker profile. The FRR measures the proportion of authentic speakers who are inaccurately matched to a speaker profile. In an aspect, the FAR and FRR values are within the interval of (0,1).

The FAR and FRR values for each unique score S_{c,x} are derived from the trials for each checkpoint c and score in position x of a score list as follows:

$$FAR ( {s}_{c , x} ) = \frac{\# of imposter trials having Sc , x \geq th}{\# total imposter trials having Sc , x} ,$$

where th is a user-defined value,

$$FRR ( {s}_{c , x} ) = \frac{\# authentic trials having Sc , x < th}{\# total authentic trials for Sc , x} ,$$

where th is a user-defined value.

The threshold generation component 318 represents the speaker recognition system as an MDP from the scores generated from the trials (block 406). As noted above, the MDP is represented as (S, A, T, R, γ), where S is a set of states and a state is a unique score at a particular checkpoint, A is a set of actions available in a state, T is a transition model, R is a reward function, and γ is a discount factor.

The actions, rewards and discount factor are user-defined values. In an aspect, the reward is defined for a state-action pair as follows:

TABLE A

| Action a | Next state s′ | Reward r |
|---|---|---|
| wait (c < 15) | map scores | 0 |
| Accept | CA | 1 |
| Accept | FA | −1000 |
| Reject | CR | 1 |
| Reject | FR | −100 |

The reward function shown in Table A is configured to encourage making a decision at an earlier checkpoint. To meet this objective, the reward function is set to minimize waiting (reward=0), penalize false acceptance (reward=−1000) and false rejection (reward=−100), and promote correct acceptance (CA=1) and correct rejection (CR=1).

The discount factor is a tunable parameter that is used to discount future rewards in order to steer the system to making decisions as quickly as possible. The discount factor typically ranges from 0.95 to 0.99. In an aspect, the discount factor is set to 0.95.

The transition model T specifies a conditional probability (Pr (St=s′|St−1=s, At−1=a)) of transitioning from state s to a next state s′ when taking the action, a at a current state s. The threshold generation component 318 computes the transition probabilities based exclusively on the FAR and FRR values for a state rather than generating a complete probabilistic representation of the speaker recognition system. These probabilities are used in the reinforcement learning technique to determine the optimal policy.

In an aspect, the transition probabilities for a final accept decision are as follows:

$$P ( CA , r \vert {s}_{c , x} , accept ) = \frac{1 - FRR ( {s}_{c , x} ) + ϵ}{{denom}_{acc , c , x}} \vert \begin{matrix}i \\ x = 1\end{matrix} ,$$

where ϵ is an optional adjustment factor (e.g., 1e-4) set to handle zero-divided-by-zero at the extremes.

$$P ( FA , r \vert {s}_{c , x} , accept ) = \frac{FAR ( {s}_{c , x} ) + ϵ}{{denom}_{acc , c , x}} \vert \begin{matrix}i \\ x = 1\end{matrix}$$

$${denom}_{acc , c , x} = 1 - FRR ( {s}_{c , x} ) + ϵ + FAR ( {s}_{c , x} ) .$$

In an aspect, the transition probabilities for a final reject decision are as follows:

$$P ( CR , r \vert {s}_{c , x} , reject ) = \frac{1 - FAR ( {s}_{c , x} ) + ϵ}{{denom}_{rej , c , x}} \vert \begin{matrix}i \\ x = 1\end{matrix}$$

$$P ( FR , r \vert {s}_{c , x} , reject ) = \frac{FRR ( {s}_{c , x} ) + ϵ}{{denom}_{rej , c , x}} \vert \begin{matrix}i \\ x = 1\end{matrix}$$

$${denom}_{rej , c , x} = 1 - FRR ( {s}_{c , x} ) + ϵ + FAR ( {s}_{c , x} )$$

In an aspect, the transition probability for a wait decision at checkpoints c<15 is as follows:

$$P ( {s}_{c + 1 , y} , r \vert {s}_{c , x} , wait ) = ( ( \frac{\# {s}_{c + 1 , y}}{\# {s}_{c , x}} ) \vert y ϵ1 … j ) \vert \begin{matrix}i \\ x = 1\end{matrix} ,$$

where c is the current checkpoint, x is the score at checkpoint c, and y is the score at the next checkpoint.

For each score x at a checkpoint c, S_{c,x,} the transition probability for a wait action is based on the relative frequency of each subsequent score S_{c+1,y}∈(S_{c+1,1}, S_{c+1, 2}, . . . . S_{c+1,j}).

The threshold generation component 318 then generates the optimal policy for the MDP (block 408). An optimal policy is a mapping of an action to every state in the system that maximizes the long-term reward over time. The problem is how to determine the long-term benefit that is achieved from the actions taken over time rather than from a short-term benefit that is represented by the reward.

A value function is used to describe the long-term value of being in a given state which will lead to choosing the best action over time. A reward indicates the action that is good or bad in the immediate state but the value function accounts for what is good in the long run. The value of a state is the total amount of reward that is expected to accumulate over time starting from that state and the states that are likely to follow and the rewards available in those states. This long-term value is represented as an expected future reward that will be received after being in state s′, dampened at each step by the discount factor. The value function is used to search for the optimal policy for an MDP.

In an aspect, the policy iteration algorithm is used to determine the optimal policy for the MDP (block 408). However, it should be noted that the technique disclosed herein is not limited to the policy iteration algorithm and that other reinforcement learning techniques may be used, such as without limitation, value iteration, Monte Carlo methods, and Temporal Difference (TD) learning.

The policy iteration method is a two-step process that starts with a policy evaluation step followed by a policy improvement step. Initially, an arbitrary policy and state value function are selected. The policy evaluation step calculates a state value function for the current policy by iteratively updating the values of each state based on the expected rewards and the discounted future values under the current policy until the value function converges. The value function is as follows:

$$V ( s ) = ( {\sum }_{{s}^{′} , r} p ( {s}^{′} , r \vert s , π ( s ) ) [ r + γ V ( {s}^{′} ) ) ,$$

where V(s) is the value function for state s,
V(s′) is the value function for state s′,
p(s′,r|s,π(s)) is the probability of arriving to state s′ and obtaining the corresponding reward r, given taking action, π(s) at state s, and
γ is the discount factor controlling the importance of the future rewards.

The next step is policy improvement. The value function is used to update the policy. For each state, the cumulative values of all possible actions a at state s are compared and the action that generates the highest cumulative value becomes the new optimal policy for state s. This is represented mathematically as follows:

$$π ( s ) = arg {max}_{a} {\sum }_{{s}^{′} , r} p ( {s}^{′} , r \vert s , a ) * V ( {s}^{′} ) .$$

If the best action is better than the present policy action, then the current action is replaced with the best action. The updated policy is then used for the next iteration of policy evaluation. The process repeats the policy evaluation and policy improvement steps until the policy converges.

The optimal policy indicates the best action to take in each state. In order to extract the accept and decision thresholds for each checkpoint from the optimal policy, the optimal policy is applied to each of the scores generated from the trials (block 410). The scores at each checkpoint are ranked in descending order and a heuristic is used to extrapolate a transition point where an action changes which is then considered a decision threshold (block 412). Thereafter, the decision thresholds are output to the speaker recognition system for authentication of a voice input (block 414).

For example, referring to FIG. 7, for checkpoint 3 s, the scores from the trials 702 are input into the optimal policy for each state 704 and produce the scores 706 and actions 708 shown in score box 710. The scores and corresponding actions are ranked in descending order. A heuristic is used to select a threshold based on the transition in the actions. As shown in box 706, the actions start with accept, then transition to wait, and then to reject.

In an aspect, the heuristic chooses the score for the accept threshold 712 from the transition of the scores from the accept state to the wait state after the scores transition to the wait state a threshold number of times. The heuristic chooses the score for the reject threshold 714 based on the transition of the scores from a wait state to a reject state after the scores transition to the reject state a threshold number of times. Other heuristics may be used that account for inconsistencies in the results due to data limitations.

Attention now turns to a description of the usage of the decision thresholds in a speaker recognition system.

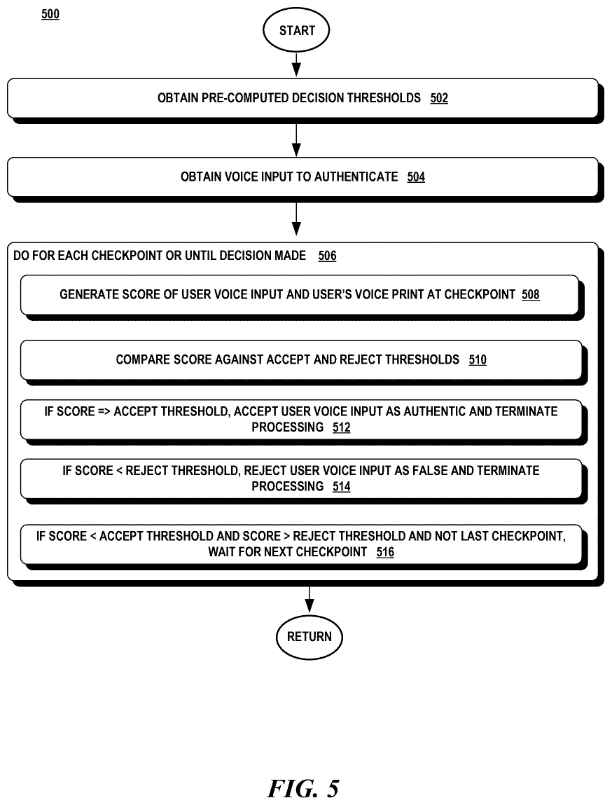

Turning to FIG. 5, there is shown an example of a method for authenticating a voice input in a speaker recognition system 500. The pre-computed decision thresholds are obtained from the decision threshold generation system 302 (block 502). The real-time speaker recognition system 304 receives a voice input to authenticate (block 504). The real-time speaker recognition system 304 processes the voice input at each checkpoint or until a decision is made (block 506).

At each checkpoint, the scoring component 314 compares the voice input with a speaker profile and generates a score (block 508). The score is compared against the accept and reject thresholds for the checkpoint (block 510). If the score equals or is greater than the accept threshold, the voice input is authenticated by the authentication component 328 (block 512). A signal is output by the authentication component 328 to the target application 334 indicating the acceptance and the speaker recognition system terminates processing (block 512).

If the score is less than the reject threshold, the voice input is rejected by the authentication component 318 (block 514). The authentication component 328 generates a signal to the target application 334 indicating the rejection and the speaker recognition system terminates processing (block 514). If the score is less than the accept threshold and greater than the reject threshold and the checkpoint is not the last checkpoint, then the authentication component 328 waits for the next checkpoint to make a decision (block 516). At the last checkpoint, the authentication component 328 makes a decision without any further waiting.

### Exemplary Operating Environment

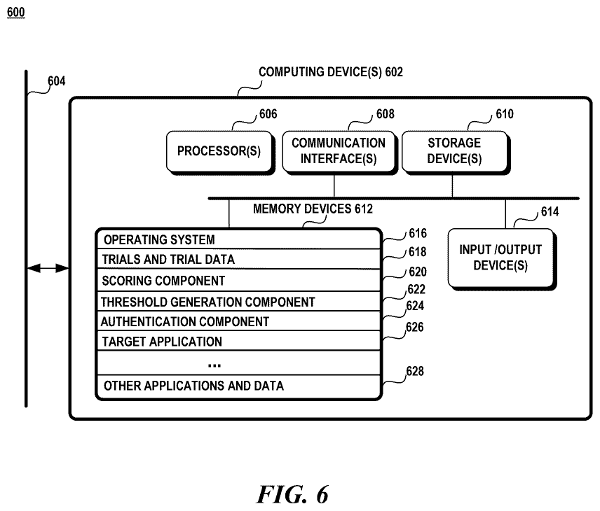

Attention now turns to a discussion of an example of an operating environment. FIG. 6 illustrates an operating environment 600 having one or more computing devices 602 communicatively coupled to a network 604. The computing devices 602 may be any type of electronic device, such as, without limitation, a mobile device, a personal digital assistant, a mobile computing device, a smart phone, a cellular telephone, a handheld computer, a server, a server array or server farm, a web server, a network server, a blade server, an Internet server, a work station, a mini-computer, a mainframe computer, a supercomputer, a network appliance, a web appliance, a distributed computing system, multiprocessor systems, or combination thereof. The operating environment 600 may be configured in a network environment, a distributed environment, a multi-processor environment, or a stand-alone computing device having access to remote or local storage devices.

The computing devices 602 may include one or more processors 606, one or more communication interfaces 608, one or more storage devices 610, one or more memory devices 612, and one or more input/output devices 614. A processor 606 may be any commercially available or customized processor and may include dual microprocessors and multi-processor architectures. A communication interface 608 facilitates wired or wireless communications between the computing device 602 and other devices. A storage device 610 may be computer-readable medium that does not contain propagating signals, such as modulated data signals transmitted through a carrier wave. Examples of a storage device 610 include without limitation random access memory (RAM), read-only memory (ROM), electrically erasable programmable read-only memory (EEPROM), flash memory or other memory technology, compact disc read-only memory (CD-ROM), digital versatile disks (DVD), or other optical storage, magnetic cassettes, magnetic tape, magnetic disk storage, all of which do not contain propagating signals, such as modulated data signals transmitted through a carrier wave. There may be multiple storage devices 610 in the computing devices 602. The input/output devices 614 may include a keyboard, mouse, pen, voice input device, touch input device, display, speakers, printers, microphone, etc., and any combination thereof.

A memory device or memory 612 may be any non-transitory computer-readable storage media that may store executable procedures, applications, and data. The computer-readable storage media does not pertain to propagated signals, such as modulated data signals transmitted through a carrier wave. It may be any type of non-transitory hardware memory device (e.g., random access memory, read-only memory, etc.), magnetic storage, volatile storage, non-volatile storage, optical storage, DVD, CD, floppy disk drive, etc. that does not pertain to propagated signals, such as modulated data signals transmitted through a carrier wave. A memory device 612 may also include one or more external hardware storage devices or remotely located hardware storage devices that do not pertain to propagated signals, such as modulated data signals transmitted through a carrier wave.

The memory device 612 may contain instructions, components, and data. A component is a software program that performs a specific function and is otherwise known as a module, program, code, and/or application. The memory device 612 may include an operating system 616, trials and trial data 618, a scoring component 620, a threshold generation component 622, an authentication component 624, a target application 626, and other applications and data 628.

The computing devices 602 may be communicatively coupled via a network 604. The network 604 may be configured as an ad hoc network, an intranet, an extranet, a virtual private network (VPN), a local area network (LAN), a wireless LAN (WLAN), a wide area network (WAN), a wireless WAN (WWAN), a metropolitan network (MAN), the Internet, a portions of the Public Switched Telephone Network (PSTN), plain old telephone service (POTS) network, a wireless network, a WiFi® network, or any other type of network or combination of networks.

The network 604 may employ a variety of wired and/or wireless communication protocols and/or technologies. Various generations of different communication protocols and/or technologies that may be employed by a network may include, without limitation, Global System for Mobile Communication (GSM), General Packet Radio Services (GPRS), Enhanced Data GSM Environment (EDGE), Code Division Multiple Access (CDMA), Wideband Code Division Multiple Access (W-CDMA), Code Division Multiple Access 2000, (CDMA-2000), High Speed Downlink Packet Access (HSDPA), Long Term Evolution (LTE), Universal Mobile Telecommunications System (UMTS), Evolution-Data Optimized (Ev-DO), Worldwide Interoperability for Microwave Access (WiMax), Time Division Multiple Access (TDMA), Orthogonal Frequency Division Multiplexing (OFDM), Ultra-Wide Band (UWB), Wireless Application Protocol (WAP), User Datagram Protocol (UDP), Transmission Control Protocol/Internet Protocol (TCP/IP), any portion of the Open Systems Interconnection (OSI) model protocols, Session Initiated Protocol/Real-Time Transport Protocol (SIP/RTP), Short Message Service (SMS), Multimedia Messaging Service (MMS), or any other communication protocols and/or technologies.

### CONCLUSION

An automated system for generating decision thresholds for a speaker recognition system is disclosed comprising: a processor and a memory. The memory stores a program that is configured to be executed by the processor, wherein the program comprises instructions to perform acts that: obtain a plurality of trials comprising imposter voice samples and authentic voice samples; generate, by the speaker recognition system, a plurality of scores from the plurality of trials, wherein the speaker recognition system generates a score for each trial of the plurality of trials at each checkpoint of a plurality of checkpoints based on a similarity with a pre-existing speaker profile; compute a false acceptance rate (FAR) value and a false rejection rate (FRR) value for each score at each checkpoint from the plurality of scores generated from the plurality of trials; generate, from the plurality of scores from the plurality of trials, a Markov Decision Process (MDP) to represent the speaker recognition system, wherein the MDP comprises a plurality of states, a plurality of actions, and a plurality of transition probabilities, a plurality of rewards, and a discount factor, wherein a state of the plurality of states comprises a select score of the plurality of scores at a select checkpoint of the plurality of checkpoints or a terminal state that terminates processing, wherein the plurality of rewards and the discount factor are set to values that promote a decision at an earlier checkpoint, wherein a transition probability represents a probability of transitioning to a terminal state of the plurality of states based on the FAR values and the FRR values generated from the plurality of trials; generate, through reinforcement learning, an optimal policy for each state of the MDP that achieves a maximum cumulative reward; and extrapolate the decision thresholds for each checkpoint of the plurality of checkpoints from application of the optimal policy to each score of the plurality of scores of the plurality of trails, wherein the decision thresholds comprise an accept threshold and a reject threshold for each checkpoint of the plurality of checkpoints.

In an aspect of the system, the decision thresholds are output to the speaker recognition system for authentication of a voice input.

In an aspect of the system, extrapolate the decision thresholds for each checkpoint of the plurality of checkpoints from the application of the optimal policy comprises further instructions to perform acts that: generate an optimal action for each score of the plurality of scores from the plurality of trials through application of the optimal policy to each score of the plurality of scores of the plurality of trials; rank the scores and the optimal actions from the application of the optimal policy in descending score order; and select the decision thresholds for each checkpoint based on a transition in the optimal actions in the descending score order.

In an aspect of the system, the plurality of actions comprises an accept action, a reject action and a wait action, and wherein a terminal state comprises a correct acceptance, a false acceptance, a correct rejection and a false rejection.

In an aspect of the system, the plurality of transition probabilities comprises a probability of transitioning to a select terminal state given a specific reward conditioned on a specific score and specific action taken in a current state.

In an aspect of the system, the plurality of transition probabilities comprises a probability of transitioning to a wait state based on a relative frequency of each subsequent score at a next checkpoint.

In an aspect of the system, the plurality of rewards is configured for acceptance at the earlier checkpoint by setting a first reward for a wait action with no value, setting a second reward for false acceptance with a negative value, setting a third reward for false rejection with a negative value, setting a fourth reward for correct acceptance with a positive value and setting a fifth reward for correct rejection with a positive value.

In an aspect of the system, the reinforcement learning comprises policy iteration.

A computer-implemented method is disclosed for automatically generating decision thresholds for a speaker recognition system. The method comprising: generating, by the speaker recognition system, a plurality of scores from a plurality of trials comprising imposter voice samples and authentic voice samples, wherein the speaker recognition system generates a score for each trial at each checkpoint of a plurality of checkpoints; computing a false acceptance rate (FAR) value and a false rejection rate (FRR) value for each score at each checkpoint; generating, from the plurality of scores from the plurality of trials, a Markov Decision Process (MDP) to represent the speaker recognition system, wherein the MDP comprises a plurality of states, a plurality of actions, and a plurality of transition probabilities, a plurality of rewards, and a discount factor, wherein a state of the plurality of states comprises a select score of the plurality of scores at a select checkpoint of the plurality of checkpoints or a terminal state, wherein a transition probability represents a probability of transitioning to a terminal state based on the FAR values and the FRR values generated from the plurality of trials, wherein the plurality of rewards and the discount factor are set to promote a decision at an earlier checkpoint; determining, through reinforcement learning, an optimal policy for each state of the MDP that achieves a maximum cumulative reward; and generating the decision thresholds for each checkpoint of the plurality of checkpoints from the optimal policy, wherein the decision thresholds comprise an accept threshold and a reject threshold for each checkpoint of the plurality of checkpoints.

In an aspect, the method further comprises outputting the decision thresholds to the speaker recognition system for authentication of a voice input.

In an aspect, the method further comprises: generating an optimal action for each score of the plurality of scores of the plurality of trials through application of the optimal policy; ranking the scores and the optimal actions in descending score order; and selecting the decision thresholds for each checkpoint based on a transition in the ranking of the optimal actions.

In an aspect of the method, the plurality of actions comprises an accept action, a reject action and a wait action, and a terminal state comprises a correct acceptance, a false acceptance, a correct rejection and a false rejection.

In an aspect of the method, the plurality of transition probabilities comprises a probability of transitioning to a terminal state given a specific reward conditioned on a specific score and specific action taken in a current state.

In an aspect of the method, the plurality of transition probabilities comprises a probability of transitioning to a next state due to a wait action based on a relative frequency of each subsequent score at a next checkpoint.

In an aspect of the method, the plurality of rewards is configured for a decision at the earlier checkpoint by setting a first reward for a wait action with no value, setting a second reward for false acceptance with a negative value, setting a third reward for false rejection with a negative value, setting a fourth reward for correct acceptance with a positive value and setting a fifth reward for correct rejection with a positive value.

In an aspect of the method, the reinforcement learning comprises policy iteration.

A hardware storage device having stored thereon computer executable instructions that are structured to be executable by a processor of a computing device to thereby cause the computing device to perform actions to generate decision thresholds for a speaker recognition system that: obtain a plurality of trials comprising imposter voice samples and authentic voice samples; generate a plurality of scores from the plurality of trials, wherein a score of the plurality of scores indicates similarity of a select voice sample of a speaker with a known voice print of the speaker at a particular checkpoint; compute a false acceptance rate (FAR) value and a false rejection rate (FRR) value for each score at each checkpoint from the plurality of scores generated from the plurality of trials; generate, from the plurality of scores from the plurality of trials, a Markov Decision Process (MDP) to represent the speaker recognition system, wherein the MDP comprises a plurality of states, a plurality of actions, and a plurality of transition probabilities, a plurality of rewards, and a discount factor, wherein a state of the plurality of states comprises a select score of the plurality of scores at a select checkpoint of the plurality of checkpoints or a terminal state that terminates processing, wherein the plurality of rewards and the discount factor are set to promote a decision at an earlier checkpoint, wherein a transition probability represents a probability of transitioning to a terminal state of the plurality of states based on the FAR values and the FRR values generated from the plurality of trials; generate, through reinforcement learning, an optimal policy for the MDP that achieves a maximum cumulative reward; and extrapolate the decision thresholds for each checkpoint of the plurality of checkpoints from the optimal policy, wherein the decision thresholds comprise an accept threshold and a reject threshold for each checkpoint of the plurality of checkpoints.

In an aspect of the hardware storage device, output the decision thresholds to the speaker recognition system for authentication of a voice input.

In an aspect of the hardware storage device, extrapolate the decision thresholds for each checkpoint of the plurality of checkpoints from application of the optimal policy comprises further instructions to perform acts that: generate an optimal action for each score of the plurality of scores of the plurality of trials through application of the optimal policy; rank the scores and optimal actions in descending score order; and select the decision thresholds for each checkpoint based on a transition in the ranking of the optimal actions.

In an aspect of the hardware storage device, the plurality of actions comprises an accept action, a reject action and a wait action, and a terminal state comprises a correct acceptance, a false acceptance, a correct rejection and a false rejection.

In an aspect of the hardware storage device, the plurality of transition probabilities comprises a probability of transitioning to a terminal state given a specific reward conditioned on a specific score and specific action taken in a current state.

In an aspect of the hardware storage device, the plurality of transition probabilities comprises a probability of transitioning to a wait state based on a relative frequency of each subsequent score at a next checkpoint.

In an aspect of the hardware storage device, the plurality of rewards is configured for acceptance at an earliest checkpoint by setting a first reward for a wait action with no value, setting a second reward for false acceptance with a negative value, setting a third reward for false rejection with a negative value, setting a fourth reward for correct acceptance with a positive value and setting a fifth reward for correct rejection with a positive value.

One of ordinary skill in the art understands that the technical effects are the purpose of a technical embodiment. The mere fact that a calculation is involved in an embodiment does not remove the presence of the technical effects or alter the concrete and technical nature of the embodiments. Operations used to perform a particular task using a particular set of inputs are clearly digital. The human mind cannot interface directly with a CPU or network interface card, or other processor, or with RAM or other digital storage, to read or write the necessary data and perform the necessary operations on digital values in the manner disclosed herein. The embodiments are also presumed to be capable of operating at scale, within tight timing constraints in production environments, or in testing labs for production environments as opposed to being mere thought experiments.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It may be appreciated that the representative methods do not necessarily have to be executed in the order presented, or in any particular order, unless otherwise indicated. Moreover, various activities described with respect to the methods can be executed in serial or parallel fashion, or any combination of serial and parallel operations. In one or more aspects, the methods illustrate operations for the systems and devices disclosed herein.

What is claimed:

1. An automated system for generating decision thresholds for a speaker recognition system, comprising:
a processor and a memory;
wherein the memory stores a program that is configured to be executed by the processor, wherein the program comprises instructions to perform acts that:
obtain a plurality of voice samples comprising imposter voice samples and authentic voice samples;
generate a plurality of scores from the plurality of voice samples, wherein a score is generated for each checkpoint of a plurality of checkpoints based on a similarity with a pre-existing speaker profile;
compute a false acceptance rate (FAR) value and a false rejection rate (FRR) value for each score at each checkpoint from the plurality of scores;
generate, from the plurality of scores, a Markov Decision Process (MDP) to represent the speaker recognition system, wherein the MDP comprises a plurality of states, a plurality of actions, and a plurality of transition probabilities, a plurality of rewards, and a discount factor, wherein a state of the plurality of states comprises a select score of the plurality of scores at a select checkpoint of the plurality of checkpoints or a terminal state that terminates processing, wherein the plurality of rewards and the discount factor are set to values that promote a decision at an earlier checkpoint, wherein a transition probability represents a probability of transitioning to a terminal state of the plurality of states based on the FAR values and the FRR values generated from the plurality of scores;
generate, through reinforcement learning, an optimal policy for each state of the MDP that achieves a maximum cumulative reward; and
extrapolate the decision thresholds for each checkpoint of the plurality of checkpoints from application of the optimal policy to each score of the plurality of scores, wherein the decision thresholds comprise an accept threshold and a reject threshold for each checkpoint of the plurality of checkpoints.

2. The system of claim 1, wherein the program comprises instructions to perform acts that:
output the decision thresholds to the speaker recognition system for authentication of a voice input.

3. The system of claim 1, wherein extrapolate the decision thresholds for each checkpoint of the plurality of checkpoints from the application of the optimal policy comprises further instructions to perform acts that:
generate an optimal action for each score of the plurality of scores through application of the optimal policy to each score of the plurality of scores;
rank the scores and the optimal actions from the application of the optimal policy in descending score order; and
select the decision thresholds for each checkpoint based on a transition in the optimal actions in the descending score order.

4. The system of claim 1,
wherein the plurality of actions comprises an accept action, a reject action and a wait action, and
wherein a terminal state comprises a correct acceptance, a false acceptance, a correct rejection and a false rejection.

5. The system of claim 1, wherein the plurality of transition probabilities comprises a probability of transitioning to a select terminal state given a specific reward conditioned on a specific score and specific action taken in a current state.

6. The system of claim 1, wherein the plurality of transition probabilities comprises a probability of transitioning to a wait state based on a relative frequency of each subsequent score at a next checkpoint.

7. The system of claim 1, wherein the plurality of rewards is configured for acceptance at the earlier checkpoint by setting a first reward for a wait action with no value, setting a second reward for false acceptance with a negative value, setting a third reward for false rejection with a negative value, setting a fourth reward for correct acceptance with a positive value and setting a fifth reward for correct rejection with a positive value.

8. A computer-implemented method for automatically generating decision thresholds for a speaker recognition system, comprising:
generating a plurality of scores from a plurality of voice samples comprising imposter voice samples and authentic voice samples, wherein a score is generated for each voice sample of the plurality of voice samples at each checkpoint of a plurality of checkpoints;
computing a false acceptance rate (FAR) value and a false rejection rate (FRR) value for each score of the plurality of scores;
generating, from the plurality of scores, a Markov Decision Process (MDP) to represent the speaker recognition system, wherein the MDP comprises a plurality of states, a plurality of actions, and a plurality of transition probabilities, a plurality of rewards, and a discount factor, wherein a state of the plurality of states comprises a select score of the plurality of scores at a select checkpoint of the plurality of checkpoints or a terminal state, wherein a transition probability represents a probability of transitioning to a terminal state based on the FAR values and the FRR values generated from the plurality of scores;
determining, through reinforcement learning, an optimal policy for each state of the MDP that achieves a maximum cumulative reward; and
generating the decision thresholds for each checkpoint of the plurality of checkpoints from the optimal policy, wherein the decision thresholds comprise an accept threshold and a reject threshold for each checkpoint of the plurality of checkpoints.

9. The computer-implemented method of claim 8, further comprising:
outputting the decision thresholds to the speaker recognition system for authentication of a voice input.

10. The computer-implemented method of claim 8, further comprising:
generating an optimal action for each score of the plurality of scores through application of the optimal policy;
ranking the scores and the optimal actions in descending score order; and
selecting the decision thresholds for each checkpoint based on a transition in the ranking of the optimal actions.

11. The computer-implemented method of claim 9,
wherein the plurality of actions comprises an accept action, a reject action and a wait action, and
wherein a terminal state comprises a correct acceptance, a false acceptance, a correct rejection and a false rejection.

12. The computer-implemented method of claim 8, wherein the plurality of transition probabilities comprises a probability of transitioning to a terminal state given a specific reward conditioned on a specific score and specific action taken in a current state.

13. The computer-implemented method of claim 8, wherein the plurality of transition probabilities comprises a probability of transitioning to a next state due to a wait action based on a relative frequency of each subsequent score at a next checkpoint.

14. The computer-implemented method of claim 8, wherein the plurality of rewards is configured for a decision at an earlier checkpoint by setting a first reward for a wait action with no value, setting a second reward for false acceptance with a negative value, setting a third reward for false rejection with a negative value, setting a fourth reward for correct acceptance with a positive value and setting a fifth reward for correct rejection with a positive value.

15. A hardware storage device having stored thereon computer executable instructions that are structured to be executable by a processor of a computing device to thereby cause the computing device to perform actions to generate decision thresholds for a speaker recognition system that:
obtain a plurality of voices samples comprising imposter voice samples and authentic voice samples;
generate a plurality of scores for the plurality of voices samples, wherein a score of the plurality of scores indicates similarity of a select voice sample of a speaker with a known voice print of the speaker at a particular checkpoint;
compute a false acceptance rate (FAR) value and a false rejection rate (FRR) value for each score at each checkpoint from the plurality of scores;
generate, from the plurality of scores, a Markov Decision Process (MDP) to represent the speaker recognition system, wherein the MDP comprises a plurality of states, a plurality of actions, and a plurality of transition probabilities, a plurality of rewards, and a discount factor, wherein a state of the plurality of states comprises a select score of the plurality of scores at a select checkpoint of the plurality of checkpoints or a terminal state that terminates processing, wherein the plurality of rewards and the discount factor are set to promote a decision at an earlier checkpoint, wherein a transition probability represents a probability of transitioning to a terminal state of the plurality of states based on the FAR values and the FRR values generated from the plurality of trials;
generate, through reinforcement learning, an optimal policy for the MDP that achieves a maximum cumulative reward; and
extrapolate the decision thresholds for each checkpoint of the plurality of checkpoints from the optimal policy, wherein the decision thresholds comprise an accept threshold and a reject threshold for each checkpoint of the plurality of checkpoints.

16. The hardware storage device of claim 15, having stored thereon computer executable instructions that are structured to be executable by a processor of a computing device to thereby cause the computing device to perform actions to generate decision thresholds for a speaker recognition system that:
output the decision thresholds to the speaker recognition system for authentication of a voice input.

17. The hardware storage device of claim 15, wherein extrapolate the decision thresholds for each checkpoint of the plurality of checkpoints from application of the optimal policy comprises further instructions to perform acts that:
generate an optimal action for each score of the plurality of scores of the plurality of trials through application of the optimal policy;
rank the scores and optimal actions in descending score order; and
select the decision thresholds for each checkpoint based on a transition in the ranking of the optimal actions.

18. The hardware storage device of claim 15,
wherein the plurality of actions comprises an accept action, a reject action and a wait action, and
wherein a terminal state comprises a correct acceptance, a false acceptance, a correct rejection and a false rejection.

19. The hardware storage device of claim 15, wherein the plurality of transition probabilities comprises a probability of transitioning to a terminal state given a specific reward conditioned on a specific score and specific action taken in a current state.

20. The hardware storage device of claim 15, wherein the plurality of rewards is configured for acceptance at an earliest checkpoint by setting a first reward for a wait action with no value, setting a second reward for false acceptance with a negative value, setting a third reward for false rejection with a negative value, setting a fourth reward for correct acceptance with a positive value and setting a fifth reward for correct rejection with a positive value.
